(19) United States
(12) Patent Application Publication
(10) Pub. No.: US 2019/0071922 A1
(43) Pub. Date: Mar. 7, 2019

(54) Adhesive Barrier System

(71) Applicant: Sheila Peterson, Odenton, MD (US)

(72) Inventor: Sheila Peterson, Odenton, MD (US)

(21) Appl. No.: 15/696,623

(22) Filed: Sep. 6, 2017

(51) Int. Cl. E06B 7/36; E06B 9/24

(52) U.S. Cl. CPC E06B 7/367; E06B 9/24

(57) ABSTRACT

An adhesive barrier system for enhancing privacy in bathroom stall includes a bathroom stall that has a wall and a door that is hingedly coupled to the wall. A strip is selectively positioned to extend vertically between the door and the wall. The strip is comprised of an opaque material to obstruct vision between the door and the wall. A plurality of adhesive pads is provided. Each of the adhesive pads is coupled to the strip. Each of the adhesive pads adheres to the wall and the door to retain the strip on the wall and the door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to barrier devices and more particularly pertains to a new barrier device for enhancing privacy in a bathroom stall.

### BRIEF SUMMARY OF THE INVENTION

An embodiment of the disclosure meets the needs presented above by generally comprising a bathroom stall that has a wall and a door that is hingedly coupled to the wall. A strip is selectively positioned to extend vertically between the door and the wall. The strip is comprised of an opaque material to obstruct vision between the door and the wall. A plurality of adhesive pads is provided. Each of the adhesive pads is coupled to the strip. Each of the adhesive pads adheres to the wall and the door to retain the strip on the wall and the door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a strip of an adhesive barrier system according to an embodiment of the disclosure.

FIG. 2 is a right side view of strip of an embodiment of the disclosure.

FIG. 3 is a back perspective view of an embodiment of the disclosure.

FIG. 4 is a perspective in-use view of an embodiment of the disclosure.

FIG. 5 is a phantom perspective view of an alternative embodiment of the disclosure.

### DETAILED DESCRIPTION OF THE INVENTION

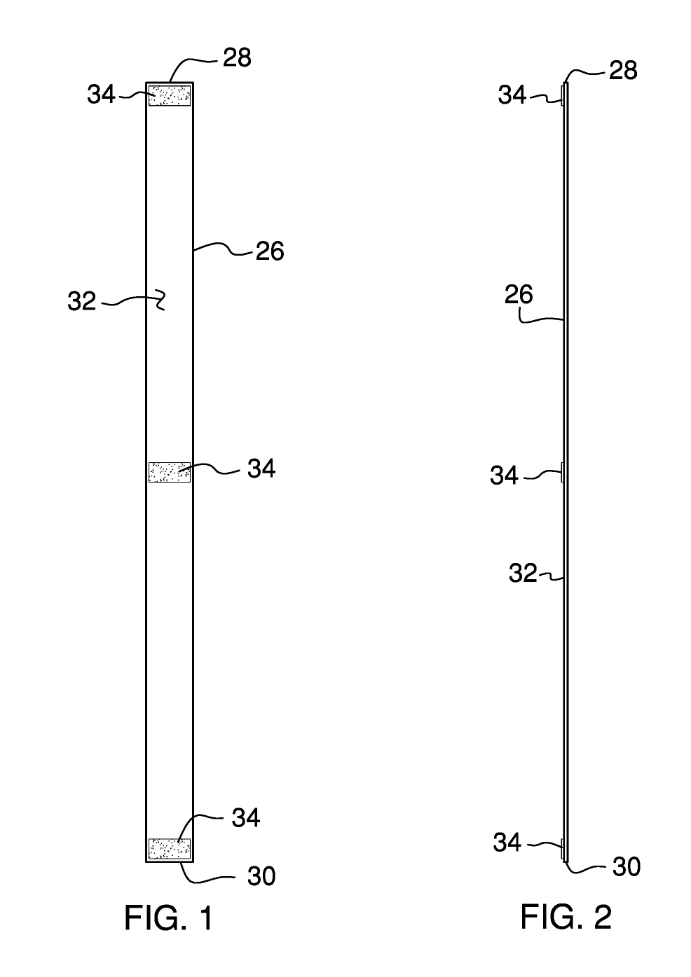

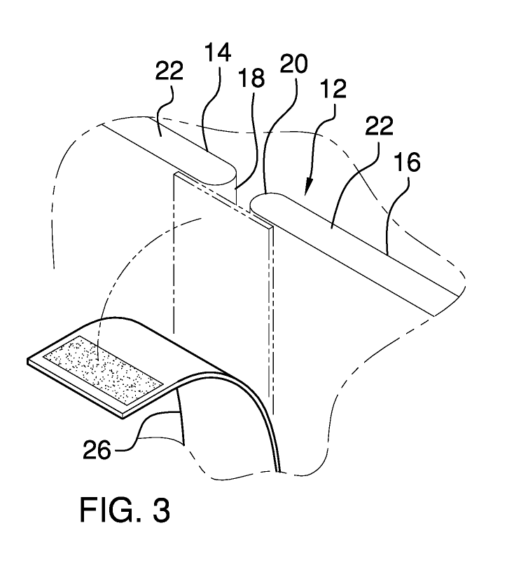

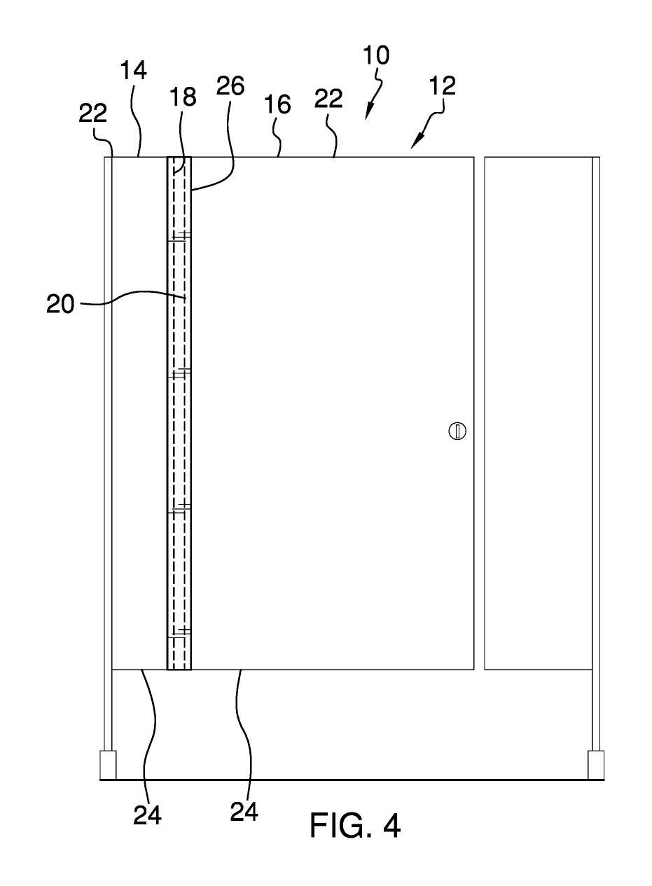

With reference now to the drawings, and in particular to FIGS. 1 through 5 thereof, a new barrier device embodying the principles and concepts of an embodiment of the disclosure and generally designated by the reference numeral 10 will be described.

As best illustrated in FIGS. 1 through 5, the adhesive barrier system 10 generally comprises a bathroom stall 12 that has a wall 14 and a door 16 that is hingedly coupled to the wall 14. The wall 14 has a first lateral edge 18 and the door 16 has a first lateral edge 20. The first lateral edge 20 of the door 16 is hingedly coupled to the first lateral edge 18 of the wall 14. Moreover, the first lateral edge 20 of the door 16 is spaced from the first lateral edge 18 of the wall 14. Each of the door 16 and the wall 14 has a top edge 22 and a bottom edge 24. The bathroom stall 12 may be a public bathroom stall 12 or the like.

A strip 26 is provided and the strip 26 is selectively positioned to extend vertically between the door 16 and the wall 14. The strip 26 is comprised of an opaque material to obstruct vision between the door 16 and the wall 14. In this way the strip 26 enhances privacy for a user with respect to inhibiting an observer from seeing the user between the door 16 and the well. The strip 26 has a first end 28, a second end 30 and a first surface 32 extending therebetween and the strip 26 is elongated between the first end 28 and the second end 30. The first surface 32 of the strip 26 abuts the door 16 and the wall 14. Moreover, the strip 26 extends between the top edge 22 of the door 16 and the wall 14 and the bottom edge 24 of the door 16 and the wall 14.

A plurality of adhesive pads 34 is provided and each of the adhesive pads 34 is coupled to the strip 26. Each of the adhesive pads 34 adheres to the wall 14 and the door 16 to retain the strip 26 on the wall 14 and the door 16. Each of the adhesive pads 34 is positioned on the first surface 32 of the strip 26. The adhesive pads 34 are spaced apart from each other and are distributed between the first end 28 and the second end 30 of the strip 26.

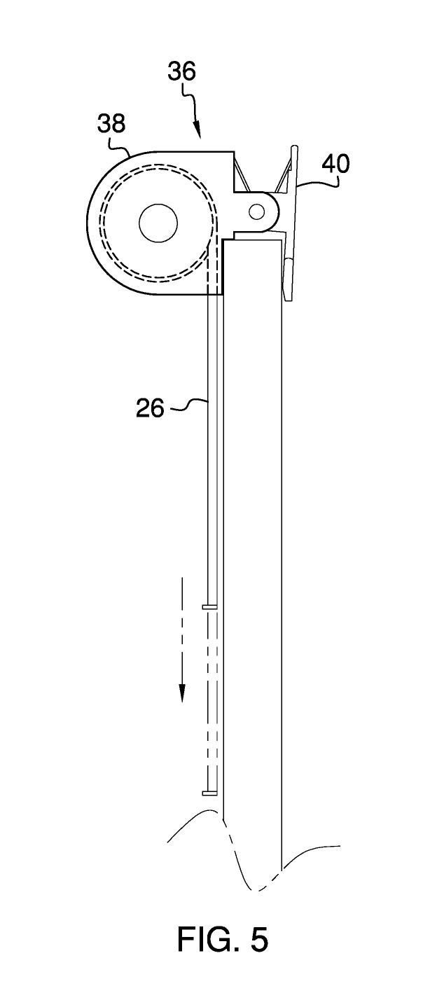

In an alternative embodiment 36 as shown in FIG. 5, a dispenser 38 may be provided and the dispenser 38 may include a clip 40. The clip 40 may engage the top edge 22 of the door 16 to retain the dispenser 38 on the door 16. The dispenser 38 may include a spring loaded spool or the like for selectively retracting the strip 26 into the dispenser 36. The strip 26 may be retractably positioned in the dispenser 38 such that the strip 26 is selectively drawn outwardly from the dispenser 38. The dispenser 38 may be aligned with a gap between the door 16 and the wall 14. In this way the strip 26 is selectively positioned between the door 16 and the wall 14 when the strip 26 is drawn outwardly from the dispenser. The strip is retracted into the dispenser 38 and the dispenser 38 is carried in a purse or the like when the user is finished using the bathroom stall 12.

In use, the strip 26 is positioned to extend vertically between the door 16 and the wall 14 the bathroom stall 12 is occupied. The strip 26 is manipulated such that each of the adhesive pads 34 adheres to the wall 14 and the door 16. Thus, the strip 26 covers a gap between the door 16 and the wall 14 thereby enhancing privacy when the bathroom stall 12 is occupied. The strip 26 is removed from the door 16 and the wall 14 when the bathroom stall 12 is finished being occupied and the strip 26 is discarded.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adhesive barrier system being positioned between a bathroom stall door and a wall, said system comprising:
a bathroom stall having a wall and a door being hingedly coupled to said wall;
a strip being selectively positioned between said door and said wall, said strip being comprised of an opaque material wherein said strip is configured to obstruct vision between said door and said wall; and
a plurality of adhesive pads, each of said adhesive pads being coupled to said strip, each of said adhesive pads adhering to said wall and said door to retain said strip on said wall and said door.

2. The assembly according to claim 1, wherein said wall has a first lateral edge, said door having a first lateral edge, said first lateral edge of said door being hingedly coupled to said first lateral edge of said wall having said first lateral edge of said door being spaced from said first lateral edge of said wall, each of said door and said wall having a top edge and a bottom edge.

3. The assembly according to claim 1, wherein:
each of said door and said wall has a top edge and a bottom edge; and
said strip has a first end, a second end and a first surface extending therebetween, said strip being elongated between said first end and said second end, said first surface of said strip abutting said door and said wall having said strip extending between said top edge of said door and said wall and said bottom edge of said door and said wall.

4. The assembly according to claim 3, wherein each of said adhesive pads is positioned on said first surface of said strip, said adhesive pads being spaced apart from each other and being distributed between said first end and said second end of said strip.

5. An adhesive barrier system being positioned between a bathroom stall door and a wall, said system comprising:
a bathroom stall having a wall and a door being hingedly coupled to said wall, said wall having a first lateral edge, said door having a first lateral edge, said first lateral edge of said door being hingedly coupled to said first lateral edge of said wall having said first lateral edge of said door being spaced from said first lateral edge of said wall, each of said door and said wall having a top edge and a bottom edge;
a strip being selectively positioned between said door and said wall, said strip being comprised of an opaque material wherein said strip is configured to obstruct vision between said door and said wall, said strip having a first end, a second end and a first surface extending therebetween, said strip being elongated between said first end and said second end, said first surface of said strip abutting said door and said wall having said strip extending between said top edge of said door and said wall and said bottom edge of said door and said wall; and
a plurality of adhesive pads, each of said adhesive pads being coupled to said strip, each of said adhesive pads adhering to said wall and said door to retain said strip on said wall and said door, each of said adhesive pads being positioned on said first surface of said strip, said adhesive pads being spaced apart from each other and being distributed between said first end and said second end of said strip.
